(19) United States
(12) Patent Application Publication
(10) Pub. No.: US 2025/0312831 A1
(43) Pub. Date: Oct. 9, 2025

(54) TANK CLEANING DEVICE AND ASSOCIATED METHODS OF USE

(71) Applicant: Pro Chemical Ltd, Iron River (CA)

(72) Inventors: Daniel Gerard Gamache, Iron River (CA); James Wade MacEachern, Iron River (CA)

(21) Appl. No.: 18/628,515

(22) Filed: Apr. 5, 2024

(51) Int. Cl. B08B 9/093; E02F 3/96

(52) U.S. Cl. CPC B08B 9/0933; B08B 2209/08; E02F 3/96

(57) ABSTRACT

A device may include a first extendable portion. A device may include a second extendable portion hingedly coupled to the first extendable portion. A device may include at least one cleaning tool coupled to the second extendable portion. A device may include a mount for attaching and detaching the tank cleaning device to a vehicle.

### BACKGROUND

Oil skim tanks require periodic maintenance to remove sand, soil, heavy metal salts, paraffin, asphalt and other heavy oil component (also referred to as “mechanical impurities” herein) that settles towards the bottom of the skim tank. This periodic maintenance is often performed manually. Manual maintenance requires operators to suit up in heavy-duty (“Hazmat”) type suits, and physically enter into the oil storage tank, where the operators manually spray out and remove said mechanical impurities. This requires the operator to enter within a “manway” in the side of the storage tank, and requires the operator to be within a harsh environment exposed to chemicals, gasses, and other undesirable environmental conditions.

### SUMMARY

In some aspects, the techniques described herein relate to a tank cleaning device, including: a first extendable portion; a second extendable portion hingedly coupled to the first extendable portion; at least one cleaning tool coupled to the second extendable portion; a mount for attaching and detaching the tank cleaning device to a vehicle.

In some aspects, the techniques described herein relate to a tank cleaning device, further including an actuator coupled between the first extendable portion and the second extendable portion.

In some aspects, the techniques described herein relate to a tank cleaning device, the actuator being a hydraulic actuator.

In some aspects, the techniques described herein relate to a tank cleaning device, the first extendable portion including a first telescoping section and second telescoping section sized and shaped to fit within the first telescoping section.

In some aspects, the techniques described herein relate to a tank cleaning device, the first extendable portion further including a hydraulic telescoping cylinder operable to extend and retract the first extendable portion.

In some aspects, the techniques described herein relate to a tank cleaning device, a first portion of the hydraulic telescoping cylinder located within the first telescoping section.

In some aspects, the techniques described herein relate to a tank cleaning device, further including a controller located on the mount for controlling extension and retraction of the first extendable portion and the second extendable portion.

In some aspects, the techniques described herein relate to a tank cleaning device, the controller including hydraulic valves coupled with hydraulic lines coupled to hydraulic actuators respectively controlling the extension and retraction of the first extendable portion and the second extendable portion.

In some aspects, the techniques described herein relate to a tank cleaning device, the hydraulic lines located internal to the first extendable portion.

In some aspects, the techniques described herein relate to a tank cleaning device, further including at least one support external to the first extendable portion, the hydraulic lines being supported by the at least one support.

In some aspects, the techniques described herein relate to a tank cleaning device, further including at least one support external to the first extendable portion, the at least one support supporting a cleaning supply line coupled to the at least one cleaning tool.

In some aspects, the techniques described herein relate to a tank cleaning device, each tool of the at least one cleaning tool coupled to the second extendable portion via a coupler.

In some aspects, the techniques described herein relate to a tank cleaning device, the coupler being a quick release coupler.

In some aspects, the techniques described herein relate to a tank cleaning device, further including at least one guide sized and shaped to position each respective tool of the at least one cleaning tool in a retracted position such that each tool fits within an opening of a tank to be cleaned by the tank cleaning device.

In some aspects, the techniques described herein relate to a tank cleaning device, further including a supply line pipe coupled to each of the at least one tool.

In some aspects, the techniques described herein relate to a tank cleaning device, the supply line pipe including a swivel joint and an input adapted to receive a cleaning supply line.

In some aspects, the techniques described herein relate to a tank cleaning device, the supply line pipe further including a rigid portion coupled between the swivel joint and each tool of the at least one tool.

In some aspects, the techniques described herein relate to a tank cleaning device, further including: an input adapted to receive a cleaning supply line; a splitter fluidically coupling the input to a first branch and a second branch; a first termination coupling the first branch to a first section of the second extendable portion; a second termination coupling the second branch to a second section of the second extendable portion.

In some aspects, the techniques described herein relate to a tank cleaning device, each tool of the at least one cleaning tool in fluidic communication with one of the first termination and the second termination.

In some aspects, the techniques described herein relate to a tank cleaning device, each of the first extendable portion and the second extendable portion being hollow such that cleaning supply flows therewithin directly to each at least one cleaning tool.

In some aspects, the techniques described herein relate to a tank cleaning device, further including a wheel attached to the first extendable portion.

In some aspects, the techniques described herein relate to a tank cleaning device, the wheel being coupled to the first extendable portion via a hinged wheel support leg.

In some aspects, the techniques described herein relate to a tank cleaning device, the hinged wheel support leg being coupled with a hydraulic cylinder that is controllable to extend and retract the wheel support leg.

In some aspects, the techniques described herein relate to a tank cleaning device, the mount being a skid steer mounting plate. In some aspects, the techniques described herein relate to a tank cleaning device, including: a first extendable portion; a second extendable portion hingedly coupled to the first extendable portion; at least one cleaning tool coupled to the second extendable portion; a mount for attaching and detaching the tank cleaning device to a vehicle.

In some aspects, the techniques described herein relate to a tank cleaning device, further including an actuator coupled between the first extendable portion and the second extendable portion.

In some aspects, the techniques described herein relate to a tank cleaning device, the actuator being a hydraulic actuator.

In some aspects, the techniques described herein relate to a tank cleaning device, the first extendable portion including a first telescoping section and second telescoping section sized and shaped to fit within the first telescoping section.

In some aspects, the techniques described herein relate to a tank cleaning device, the first extendable portion further including a hydraulic telescoping cylinder operable to extend and retract the first extendable portion.

In some aspects, the techniques described herein relate to a tank cleaning device, a first portion of the hydraulic telescoping cylinder located within the first telescoping section.

In some aspects, the techniques described herein relate to a tank cleaning device, further including a controller located on the mount for controlling extension and retraction of the first extendable portion and the second extendable portion.

In some aspects, the techniques described herein relate to a tank cleaning device, the controller including hydraulic valves coupled with hydraulic lines coupled to hydraulic actuators respectively controlling the extension and retraction of the first extendable portion and the second extendable portion.

In some aspects, the techniques described herein relate to a tank cleaning device, the hydraulic lines located internal to the first extendable portion.

In some aspects, the techniques described herein relate to a tank cleaning device, further including at least one support external to the first extendable portion, the hydraulic lines being supported by the at least one support.

In some aspects, the techniques described herein relate to a tank cleaning device, further including at least one support external to the first extendable portion, the at least one support supporting a cleaning supply line coupled to the at least one cleaning tool.

In some aspects, the techniques described herein relate to a tank cleaning device, each tool of the at least one cleaning tool coupled to the second extendable portion via a coupler.

In some aspects, the techniques described herein relate to a tank cleaning device, the coupler being a quick release coupler.

In some aspects, the techniques described herein relate to a tank cleaning device, further including at least one guide sized and shaped to position each respective tool of the at least one cleaning tool in a retracted position such that each tool fits within an opening of a tank to be cleaned by the tank cleaning device.

In some aspects, the techniques described herein relate to a tank cleaning device, further including a supply line pipe coupled to each of the at least one tool.

In some aspects, the techniques described herein relate to a tank cleaning device, the supply line pipe including a swivel joint and an input adapted to receive a cleaning supply line.

In some aspects, the techniques described herein relate to a tank cleaning device, the supply line pipe further including a rigid portion coupled between the swivel joint and each tool of the at least one tool.

In some aspects, the techniques described herein relate to a tank cleaning device, further including: an input adapted to receive a cleaning supply line; a splitter fluidically coupling the input to a first branch and a second branch; a first termination coupling the first branch to a first section of the second extendable portion; a second termination coupling the second branch to a second section of the second extendable portion.

In some aspects, the techniques described herein relate to a tank cleaning device, each tool of the at least one cleaning tool in fluidic communication with one of the first termination and the second termination.

In some aspects, the techniques described herein relate to a tank cleaning device, each of the first extendable portion and the second extendable portion being hollow such that cleaning supply flows therewithin directly to each at least one cleaning tool.

In some aspects, the techniques described herein relate to a tank cleaning device, further including a wheel attached to the first extendable portion.

In some aspects, the techniques described herein relate to a tank cleaning device, the wheel being coupled to the first extendable portion via a hinged wheel support leg.

In some aspects, the techniques described herein relate to a tank cleaning device, the hinged wheel support leg being coupled with a hydraulic cylinder that is controllable to extend and retract the wheel support leg.

In some aspects, the techniques described herein relate to a tank cleaning device, the mount being a skid steer mounting plate.

### BRIEF DESCRIPTION OF THE FIGURES

FIG. 1 shows a system including a tank cleaning device that is used to clean the interior space of tank.

FIG. 2 shows a top perspective view of portable tank cleaning device 02, which is an example of the portable tank cleaning device of FIG. 1 but with further detail.

FIG. 3 shows a top view of the portable tank cleaning device with second extendable portions not extended.

FIG. 4 shows a front end elevational view of portable tank cleaning device with the second extendable portions not extended.

FIG. 5 shows a front end view of the portable tank cleaning device with the second extendable portions in an extended position.

FIG. 6 shows a side elevational view of the portable tank cleaning device with the wheel in an extended (“dropped”) position and the second extendable portion in a extended position.

FIG. 7 shows a side elevational view of portable tank cleaning device with the wheel in an extended position and the second extendable portion in a non extended position.

FIG. 8 shows a side view of portable tank cleaning device with the wheel in an retracted (“raised”) position and the second extendable portion in a non extended position.

FIG. 9 shows a top plan view of the portable tank cleaning device with the second extendable portion in an extended position.

FIG. 10 shows a top plan view of the portable tank cleaning device with the first and second extendable portions in an extended position . . .

### DETAILED DESCRIPTION OF THE EMBODIMENTS

The systems and methods of using said systems described herein acknowledge the realization that manual maintenance of oil tanks requires operators to enter into dangerous environmental conditions within the oil tank. The systems and methods herein resolve this realization by implementing a mechanical cleaning device that reduces and/or eliminates need for an operator to enter the tank. Moreover, the mechanical cleaning device may be portable, in that it is capable of being attached and detached to a vehicle (e.g., a skid steer) and does not require a dedicated vehicle to operate.

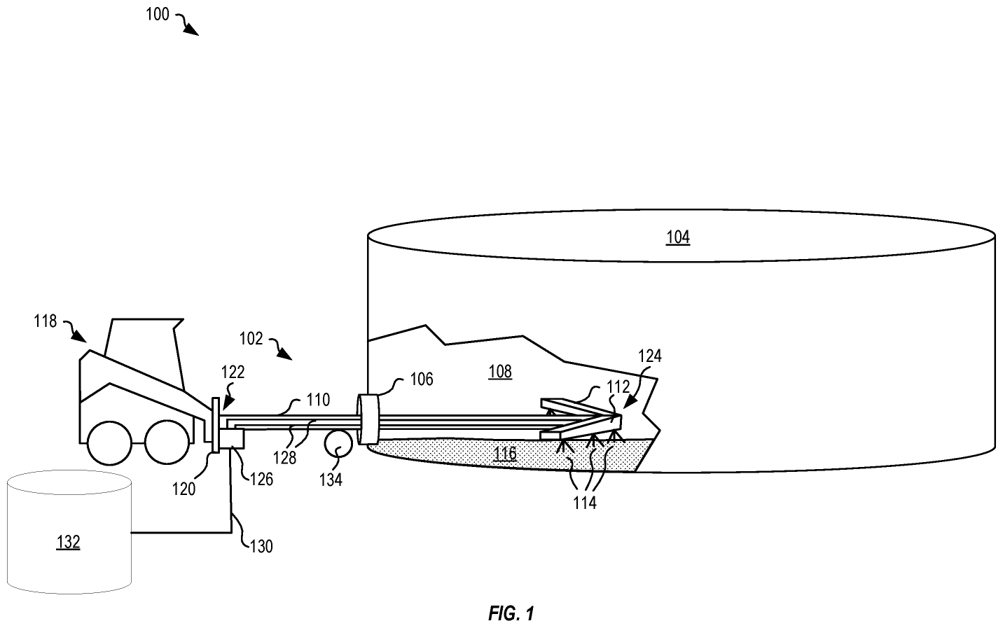

FIG. 1 shows a system 100 including a tank cleaning device 102 that is used to clean the interior space of tank 104. Tank 104 includes an opening 106 that the portable tank cleaning device 102 is inserted into to access interior space 108 of tank 104. Interior space 108 is shown via cutaway of the exterior housing of tank 104 in FIG. 1. Opening 106 may be size-limited, impacting the ability to insert and withdraw portable tank cleaning device 102 from within tank 104. For example, standard size manways for an oil skim tank, which is an example of tank 104, are 29 inches in diameter.

To accommodate these limited-diameter opening 106 of tank 104, portable tank cleaning device 102 may include a first extendable portion 110, and a second extendable portion 112. First extendable portion 110 may be a boom that is extendable in a first direction. Second extendable portion 112 may be hingedly attached to first extendable portion 110. In the example of portable tank cleaning device 102 shown in FIG. 1, second extendable portion 112 includes two arms that are hingedly attached to first extendable portion 110. Each arm may respectively hinge between 0 and 180 degrees relative to first extendable portion 110. As portable tank cleaning device 102 is being inserted into tank 104 via opening 106, the second extendable portion 112 is secured in a “closed” position, where each second extendable portion 112 is at the 0 or 180 degree position relative to first extendable portion 110. This allows for portable tank cleaning device 102 to fit within the limited-diameter of opening 106.

Each second extendable portion 112 may include one or more cleaning tools 114. A non-limiting example of one or more cleaning tools 114 includes the Model 360 Triple or Model 360 Dual Nozzles, the Jumbo Nozzle, the ORBI-G3, the ORBI-G4 nozzle, the Hygienic 2 nozzle, the Hygienic 80 nozzle, the Tankman nozzle, and the model 180 directional nozzle (each of the above are manufactured by Cloud Sellers, of San Luis Obispo, CA a Division of Spraying Systems Co.). The one or more cleaning tools 114 operate to spray and remove mechanical impurities 116 that have settled to the bottom of tank 104.

Portable tank cleaning device 102 may be portable, in that is attachable and detachable from another device, such as another vehicle 118. Vehicle 118 is shown as a skid-steer in the example of FIG. 1. As such, portable tank cleaning device 102 may include a mount 120, such as a skid steer mounting plate. Mount 120 may be located at a first end 122 of first extendable portion 110, where second extendable portion 112 is located at second end 124 of first extendable portion 110.

Portable tank cleaning device 102 may include a controller 126. In embodiments, 126 includes one or more hydraulic control valves each controlling a respective hydraulic line 128. A first respective hydraulic line 128 may operate to extend/retract first extendable portion 110 in a length-wise direction. A second hydraulic line 128 may operate to extend/retract each second extendable portion 112 (e.g., hinge outward/inward each second extendable portion 112 with respect to first extendable portion 110). Respective hydraulic line 128 may further include a cleaning-supply line 130 that operates to control cleaning supply 132 (e.g., water, or other chemical solution used to clean the tank 104) input to each of the one or more cleaning tools 114. In certain embodiments controller 126 is entirely manual and does not include electronic control components. This is because the gasses involved with certain tanks 104 are highly combustible. As such, by using only hydraulic controls, or other manual valves, the potential for electronic failure that causes a fire within tank 104 is reduced and/or eliminated.

Portable tank cleaning device 102 may further include additional support components. One such optional support component is a wheel 134. Cleaning-supply line 130 may be located on a non-extending, or extending portion of first extendable portion 110. Moreover, the respective hydraulic line 128 and/or cleaning supply line 130 may be located within first extendable portion 110 or may be supported by one or more support posts attached to first extendable portion 110.

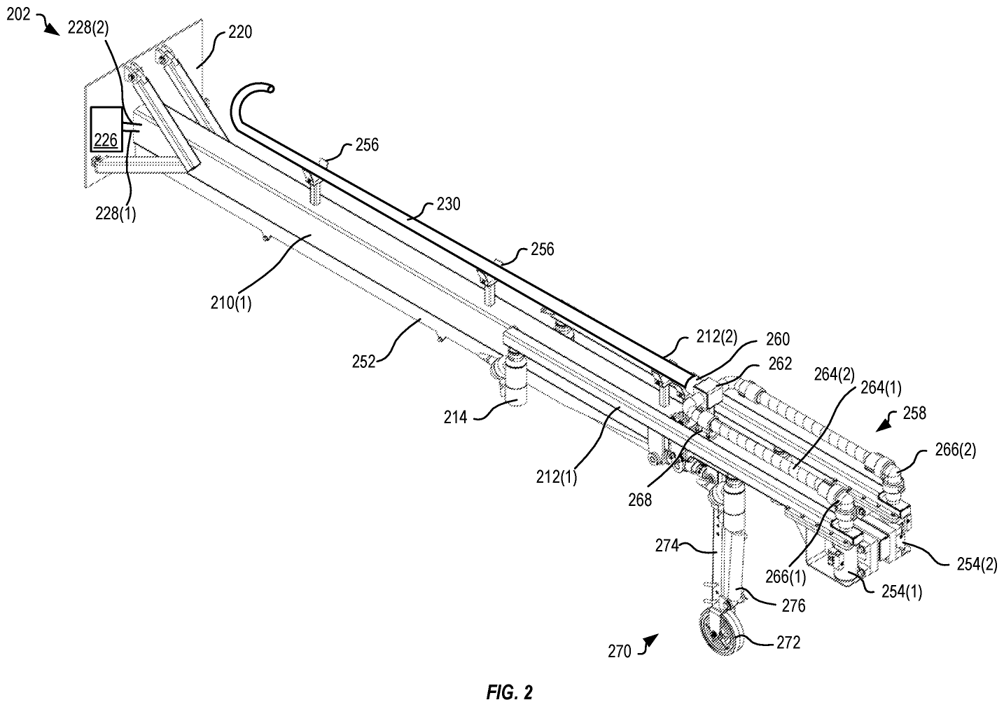

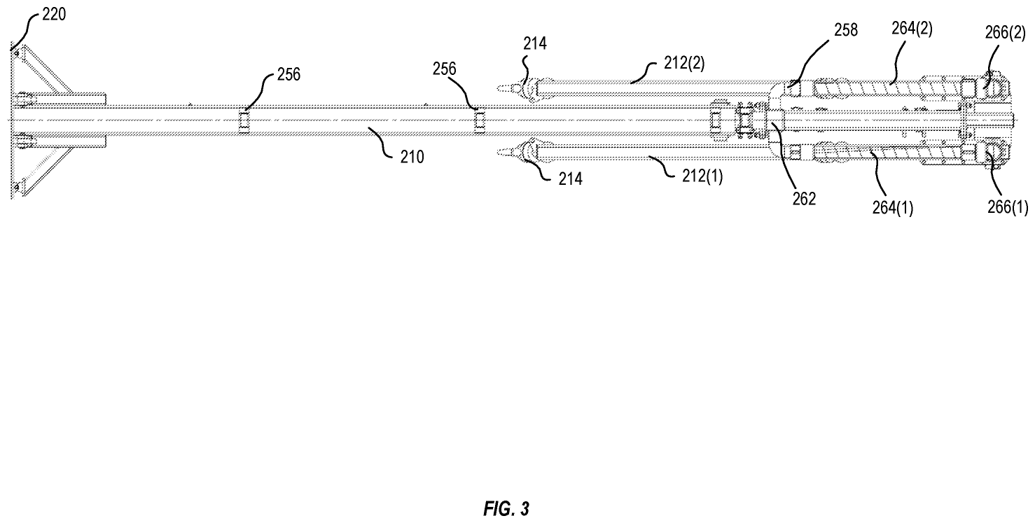

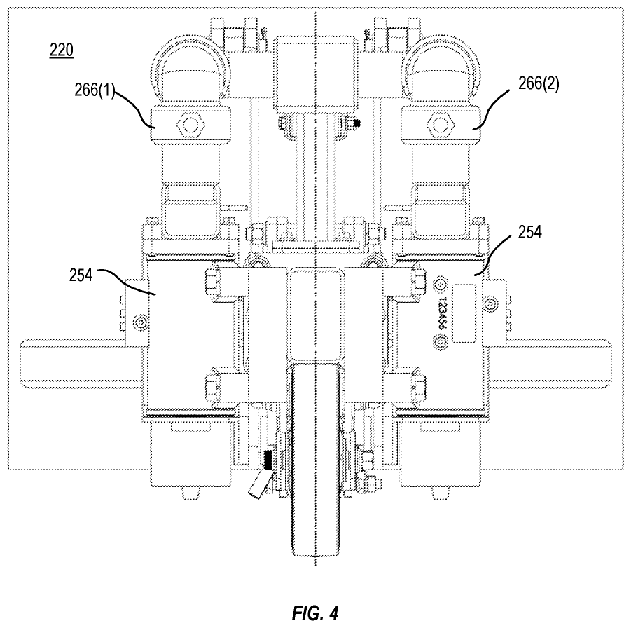

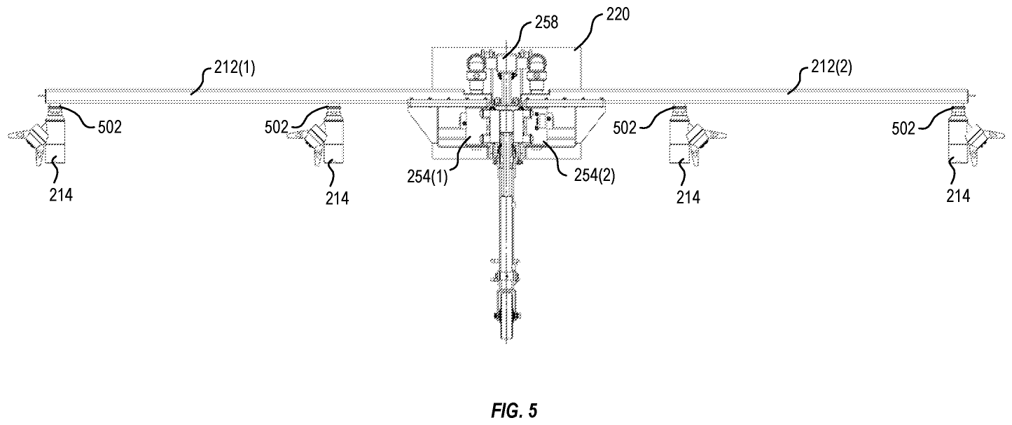

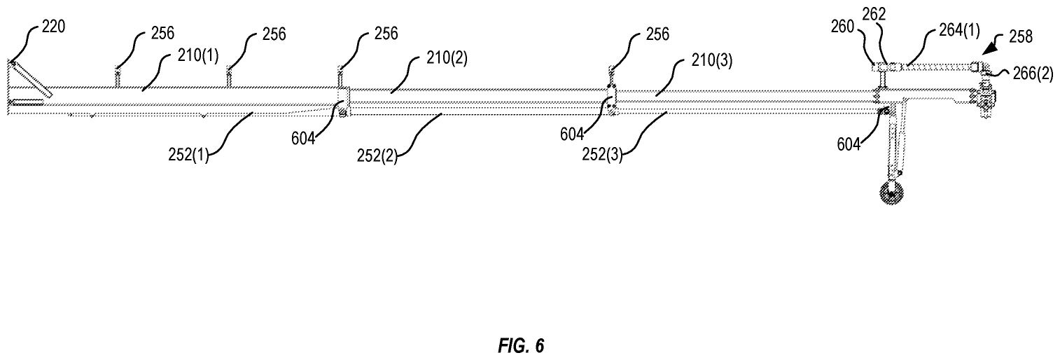

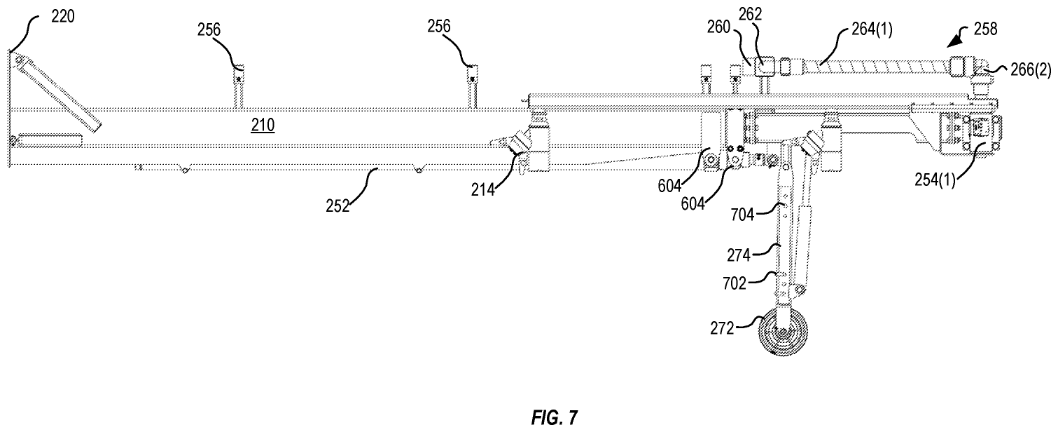

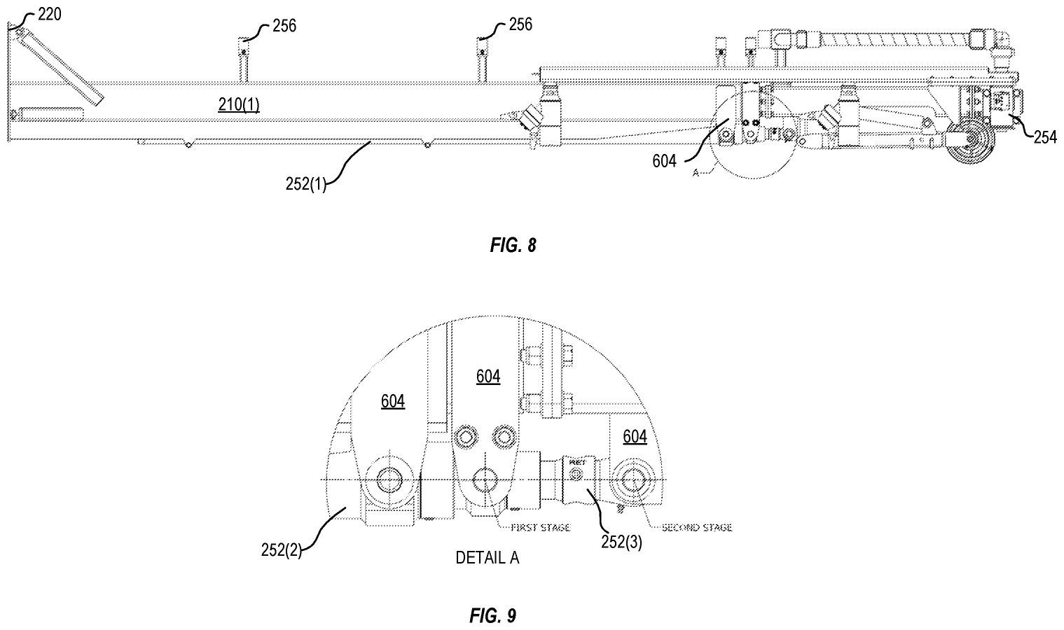

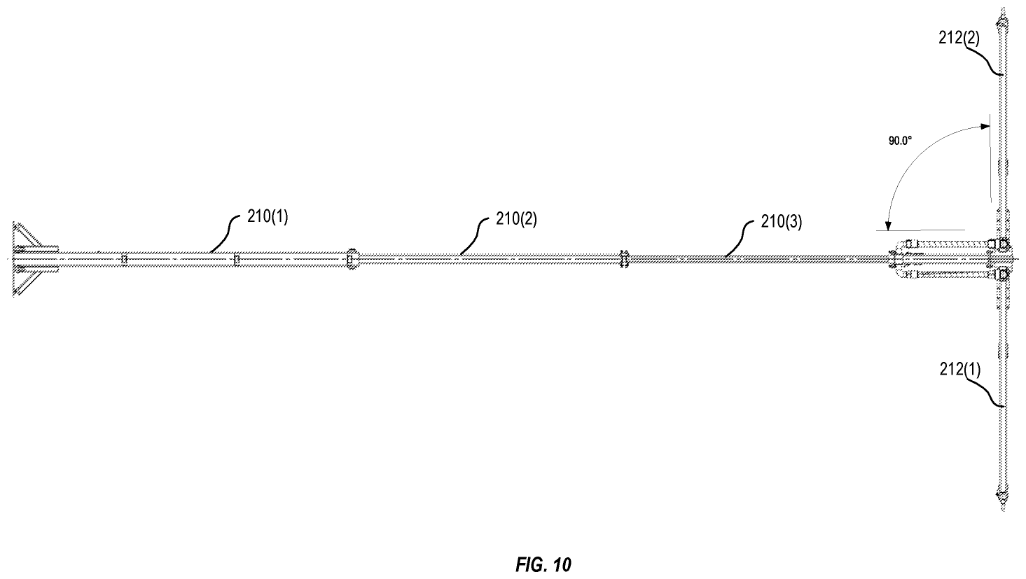

FIG. 2 shows a top perspective view of portable tank cleaning device 202, which is an example of portable tank cleaning device 102 but with further detail. FIG. 3 shows a top view of the portable tank cleaning device 202 with second extendable portions not extended. FIG. 4 shows a front end elevational view of portable tank cleaning device 202 with the second extendable portion not extended. FIG. 5 shows a front end view of the portable tank cleaning device 202 with the second extendable portion in an extended position. FIG. 6 shows a side elevational view of the portable tank cleaning device 202 with the wheel in an extended (“dropped”) position and the second extendable portion in a extended position. FIG. 7 shows a side elevational view of portable tank cleaning device 202 with the wheel in an extended position and the second extendable portion in a non extended position. FIG. 8 shows a side view of portable tank cleaning device 202 with the wheel in an retracted (“raised”) position and the second extendable portion in a non extended position. FIG. 9 shows detail A from FIG. 8 in further detail. FIG. 9 shows a top plan view of the portable tank cleaning device 202 with the second extendable portion in an extended position. FIG. 10 shows a top plan view of the portable tank cleaning device 202 with the first and second extendable portions in an extended position. FIGS. 2-10 are best viewed together with the following description.

It should be appreciated that portable tank cleaning device 202 may include all or a portion of the above-discussed features of portable tank cleaning device 102. Conversely, any feature described with respect to portable tank cleaning device 202 may be also included in the portable tank cleaning device 102 shown with respect to FIG. 1 without departing from the scope hereof.

First extendable portion 210 is coupled at one end to mount 220, which is an example of mount 120 discussed above. First extendable portion 210, which is an example of first extendable portion 110, includes a first section 210(1), second section 210(2), and third section 210(3) (shown in FIG. 6). Third section 210(3) is a smaller profile than second section 210(2), which is a smaller profile than first section 210(1) such that each section 210 is telescoping within the other. Also included with respect to first extendable portion 210 is a hydraulic telescoping cylinder 252 operable to extend and retract first extendable portion 210. As shown in FIG. 6, a first non-telescoping portion 252(1) of hydraulic telescoping cylinder 252 may be coupled to the first section 210(1), and a second telescoping portion 252(2) may be coupled to the second section 210(2), and a third telescoping portion 2522(2) may be coupled to the third section 210(3) (or otherwise the last extending portion of first extendable portion 210). As such, each section 210 may be associated with a separate telescoping portion of hydraulic telescoping cylinder 252 such that any section of first extendable portion 210 may be extended to a desired position by controlling the hydraulic telescoping cylinder 252. Alternatively, only the last section of first extendable portion 210 (e.g., 210(3)) may be associated with a telescoping portion of hydraulic telescoping cylinder 252 such that hydraulic telescoping cylinder 252 can control the extension/retraction of first extendable portion 210, where the last section first extendable portion 210 moves first, and then controls movement of intermediate sections of first extendable portion 210.

Each section 210 may include a respective mount 602 that couples with hydraulic telescoping cylinder 252. Mounts 602 are shown as flanges that extend beyond the lower portion of each section 210, but it should be appreciated that they may take other forms without departing from scope here. A first portion of hydraulic telescoping cylinder 252 may be located within first section 210(1) of first extendable portion 210, or may be located outside of first section 210(1) on the upper, lower, or side thereof. Hydraulic telescoping cylinder 252 is controlled by controller 226 via first hydraulic line 228(1), which are examples of controller 126 and respective hydraulic line 128, respectively. In embodiments, first extendable portion 210 is 20 feet in length in a contracted position, and 35 feet in length in an extended position, allowing significant input into tank 104.

Portable tank cleaning device 202 includes two second extendable portions 212(1) and 212(2), which are examples of second extendable portion 112 discussed above. Each second extendable portion 212 is coupled to the end of third section 210(3) of first extendable portion 210. Each second extendable portion 212 is hinged such that it extendable and retractable via respective hydraulicly-controlled actuators 254 (e.g., a first and second hydraulicly-controlled hydraulic actuator 254(1), 254(2), respectively). Hydraulic actuators 254(1), 254(2) may be coupled to a controller 226 via at least one hydraulic line 228. Controller 226 and at least one hydraulic line 228 are shown in FIG. 2, but not in other figures for clarity of illustration. Hydraulic lines 228 may be run internally to each section of first extendable portion 210, or may be run externally and supported by one or more supports 256. Supports 256 may be located on any of the telescoping sections of first extendable portion 210. Supports 256 are shown on the upper surface of first extendable portion 210, but may be located on either side or bottom surfaces as well. Where one or more supports 256 are located on a telescoping section of first extendable portion 210, they may be located on the end of said telescoping section nearest the second extendable portion 212 so that they don't interfere substantially with the telescoping functionality of the given telescoping section.

Each of the two second extendable portions 212(1) and 212(2) are shown in FIGS. 5, 6, and 10 extended 90 degrees, and retracted to zero degrees in FIGS. 2-4, and 7-9. However, it should be appreciated they may extend more than 90 degrees, including up to 180 degrees such that they are parallel with a longitudinal axis of first extendable portion 210. At 0 and 180 degrees, the width of the portable tank cleaning device 202 is at its smallest (e.g., the width between the outer portions of the two second extendable portions 212(1) and 212(2)). This allows portable tank cleaning device 202 to be inserted into the diameter-constraints of the opening 106. In embodiments, the width from each outer surface of 212 is 20 and ⅜ inches when folded (e.g., hinged to 0 or 180 degrees relative to the longitudinal axis of first extendable portion 210), thereby fitting within a 29 inch diameter opening 106. In an extended position (e.g., hinged 90 degrees relative to the longitudinal axis of first extendable portion 210), the cumulative length of second extendable portion 212 is approximately 15 feet. The lengths and widths of second extendable portion 212 and first extendable portion 210 described herein are examples only, and not intended to be limited in scope hereof.

Portable tank cleaning device 202 is shown with two cleaning tools 214 mounted to the bottom surface thereof. A non-limiting example of one or more cleaning tools 214 includes the Model 360 Triple or Model 360 Dual Nozzles, the Jumbo Nozzle, the ORBI-G3, the ORBI-G4 nozzle, the Hygienic 2 nozzle, the Hygienic 80 nozzle, the Tankman nozzle, and the model 180 directional nozzle (each of the above are manufactured by Cloud Sellers, of San Luis Obispo, CA a Division of Spraying Systems Co.). The one or more cleaning tools 214 operate to spray and remove mechanical impurities 116 that have settled to the bottom of tank 104.

Each two cleaning tools 214 may be mounted with a quick release. Cleaning supply (e.g., cleaning supply 132 discussed above with respect to FIG. 1) is supplied to each cleaning tool 214 via cleaning supply line 230 (which is an example of cleaning-supply line 130). Cleaning supply line 230 is shown in FIG. 2, but not the remaining figures for clarity of illustration. Cleaning supply line 230 is shown supported by one or more supports 256, but may be located internal to first extendable portion 210 without departing from the scope hereof. Cleaning supply line 230 may be a flexible hose that couples into controller 226, and whereby supply of the cleaning solution (e.g., cleaning supply 132) is provided to each of two cleaning tools 214.

Cleaning supply line 230 is shown attaching to a supply-line pipe 258. Respective rigid supply-line pipe 258 includes an inlet 260 which is in fluid communication with a splitter 262 that directs cleaning supply to one of two branches 264(1), 264(2). Branches 264(1), 264(2) may each be a flexible hose, such as a heavy-duty rubber or nitrile material hose (or other material as known in the art). Branches 264(1), 264(2) each terminate at a respective termination 266(1), 266(2) in a respective one of second extendable portion sections 212(1), 212(2). Each section 212(1), 212(2) may be hollow to allow for cleaning supply provided by cleaning supply line 230 to enter therein and allow for a fluidic path from inlet 260 to each cleaning tool 214. Alternatively, additional flexible hose similar to the material of each branch 262 may be routed within each section of second extendable portion 212 and include additional termination at the location of each cleaning tool 214. Inlet 260 and splitter 262 may be secured to the last section of first extendable portion 210 via a rigid mount 268 (e.g., metal or other non-flexible material). Moreover, each termination 266 may be rigid (e.g., metal or other non-flexible material). By making inlet 260, splitter 262, termination 266, and mount 268 rigid, while the cleaning supply line 230 and each branch 264 are flexible, this allows for replacement of each branch hose should damage occur.

In an additional or alternative embodiment, supply-line pipe 258 may not include splitter, and two cleaning supply lines cleaning supply line 230 may each be coupled directly to termination 266. As such, in some embodiments, termination 266 may form a swivel joint, and each include input 260 discussed above.

Although not shown, at the front of the device may be a guard plate located in front of termination 266 that shrouds the termination 266 from potential damage while inserting portable tank cleaning device 202 within opening 106 during deployment and use. The guard plate may be sized and shape so as to not interfere or extend substantially beyond the profile of the portable tank cleaning device 202 so as to not substantially interfere with the ability of portable tank cleaning device 202 to be sized and shaped to fit within opening 106.

Each two cleaning tools 214 may be coupled to supply pipe of each second extendable portion 212 via a coupler 502 (coupler 502 is numbered in FIG. 5 but not other figures for clarity of illustration). Coupler 502 may be a quick-release coupler, threaded coupler, or a fixed coupler (in that each two cleaning tools 214 is not removable from the one or more supports 256 of second extendable portion 212). In certain embodiments, the profile of each two cleaning tools 214 is such that it extends beyond the outer surface of each second extendable portion 212 when the second extendable portion 212 is in the retracted position (either at 0 or 180 degrees with respect to the longitudinal axis of first extendable portion 210). In such circumstances, each two cleaning tools 214 may be required to be manually coupled to coupler 502 within the tank (e.g., tank 104).

In some embodiments, coupler 502, or a separate component of second extendable portion 212, includes a guide that positions the two cleaning tools 214 when not in use to a certain position that limits the orientation of two cleaning tools 214 when not in use. When in use, two cleaning tools 214, rotates automatically based on pressure of cleaning supply 232 being supplied to the cleaning tool.

Portable tank cleaning device 202 further includes a support 270. Support 270 is an example of wheel 134 in FIG. 1. Support 270 is shown as a wheeled system. Support 270 may include a wheel 272 rotatably mounted at the end of wheel support 274. Wheel support 274 is hingedly coupled to third section 210(3) (or otherwise the last section) of first extendable portion 210. Wheel support 274 may be a drop leg that is extendable/non-extendable based on location of one or more pins 702 within associated extension apertures 704 (labeled in FIG. 7 for clarity of illustration). Wheel support 274 may be retracted (as shown in FIGS. 4 and 8) or extended (as shown in FIGS. 2 and 5-7) under control of hydraulic cylinder 276 of support 270. Hydraulic cylinder 276 may be operated by controller 226 and a hydraulic line 228 coupled between controller 226 and hydraulic cylinder 276. The location of wheel support 274 at the end of first extendable portion 210 (e.g., end of third section 210(3)), and the inclusion of hydraulic cylinder 276 to control extension/retraction thereof allows wheel support 274 to be retracted during insertion and withdrawal of portable tank cleaning device 202 within opening 106, and extended during use of portable tank cleaning device 202 while second extendable portion 212 is within tank 104.

As shown in FIG. 5, when first extendable portion 210 and wheel support 274 are both retracted, the profile of portable tank cleaning device 202 (other than mount 220) is compact such that portable tank cleaning device 202 is sized and shaped to fit within opening 106 of tank 104.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A tank cleaning device, comprising:
a first extendable portion;
a second extendable portion hingedly coupled to the first extendable portion;
at least one cleaning tool coupled to the second extendable portion;
a mount for attaching and detaching the tank cleaning device to a vehicle.

2. The tank cleaning device of claim 1, further comprising an actuator coupled between the first extendable portion and the second extendable portion.

3. The tank cleaning device of claim 2, the actuator being a hydraulic actuator.

4. The tank cleaning device of claim 1, the first extendable portion including a first telescoping section and second telescoping section sized and shaped to fit within the first telescoping section.

5. The tank cleaning device of claim 4, the first extendable portion further including a hydraulic telescoping cylinder operable to extend and retract the first extendable portion.

6. The tank cleaning device of claim 5, a first portion of the hydraulic telescoping cylinder located within the first telescoping section.

7. The tank cleaning device of claim 1, further comprising a controller located on the mount for controlling extension and retraction of the first extendable portion and the second extendable portion.

8. The tank cleaning device of claim 7, the controller including hydraulic valves coupled with hydraulic lines coupled to hydraulic actuators respectively controlling the extension and retraction of the first extendable portion and the second extendable portion.

9. The tank cleaning device of claim 8, the hydraulic lines located internal to the first extendable portion.

10. The tank cleaning device of claim 8, further comprising at least one support external to the first extendable portion, the hydraulic lines being supported by the at least one support.

11. The tank cleaning device of claim 1, further comprising at least one support external to the first extendable portion, the at least one support supporting a cleaning supply line coupled to the at least one cleaning tool.

12. The tank cleaning device of claim 1, each tool of the at least one cleaning tool coupled to the second extendable portion via a coupler.

13. The tank cleaning device of claim 12, the coupler being a quick release coupler.

14. The tank cleaning device of claim 1, further comprising at least one guide sized and shaped to position each respective tool of the at least one cleaning tool in a retracted position such that each tool fits within an opening of a tank to be cleaned by the tank cleaning device.

15. The tank cleaning device of claim 1, further comprising a supply line pipe coupled to each of the at least one tool.

16. The tank cleaning device of claim 15, the supply line pipe including a swivel joint and an input adapted to receive a cleaning supply line.

17. The tank cleaning device of claim 16, the supply line pipe further including a rigid portion coupled between the swivel joint and each tool of the at least one tool.

18. The tank cleaning device of claim 1, further comprising:
an input adapted to receive a cleaning supply line;
a splitter fluidically coupling the input to a first branch and a second branch;
a first termination coupling the first branch to a first section of the second extendable portion;
a second termination coupling the second branch to a second section of the second extendable portion.

19. The tank cleaning device of claim 18, each tool of the at least one cleaning tool in fluidic communication with one of the first termination and the second termination.

20. The tank cleaning device of claim 19, each of the first extendable portion and the second extendable portion being hollow such that cleaning supply flows therewithin directly to each at least one cleaning tool.

21. The tank cleaning device of claim 1, further comprising a wheel attached to the first extendable portion.

22. The tank cleaning device of claim 21, the wheel being coupled to the first extendable portion via a hinged wheel support leg.

23. The tank cleaning device of claim 22, the hinged wheel support leg being coupled with a hydraulic cylinder that is controllable to extend and retract the wheel support leg.

24. The tank cleaning device of claim 1, the mount being a skid steer mounting plate.
